(19) United States
(12) Patent Application Publication
(10) Pub. No.: US 2022/0097015 A1
(43) Pub. Date: Mar. 31, 2022

(54) MEASUREMENT APPARATUS FOR MEASURING AXIAL TEMPERATURE PROFILES IN A REACTOR TUBE

(71) Applicant: L'Air Liquide, Société Anonyme pour l'Etude et l'Exploitation des Procédés Georges Claude, Paris (FR)

(72) Inventors: Frank BRUDER, Oranienburg (DE); Dieter ULBER, Steinbach (DE); Marion DAVID, Jouy-en-Josas (FR); Daniel GARY, Montigny le Bretonneux (FR)

(21) Appl. No.: 17/484,744

(22) Filed: Sep. 24, 2021

(30) Foreign Application Priority Data
Sep. 25, 2020 (EP) 20020431.1

(51) Int. Cl. B01J 8/00; G01K 1/14; G01K 7/04

(52) U.S. Cl. CPC B01J 8/003; G01K 1/14; B01J 2208/00769; B01J 2208/00061; G01K 7/04

(57) ABSTRACT

Described herein are a measurement apparatus for measuring axial temperature profiles in a reactor tube, a connecting piece for connecting the reactor tube to a feed pipe configured as a thermal stress compensator for a reaction input stream and for lateral introduction of a multipoint thermocouple into the reactor tube, the use of the connecting piece/measurement apparatus for measuring axial temperature profiles in a reformer tube for steam reforming of hydrocarbons and a process for installing the measurement apparatus.

### CROSS REFERENCE TO RELATED APPLICATIONS

This application claims priority to EP 20020431.1, filed Sep. 25, 2020, the entire contents of which are incorporated herein by reference.

### BACKGROUND

### Field of the Invention

The present invention relates to
a measurement apparatus for measuring axial temperature profiles in a reactor tube,
a connecting piece for connecting the reactor tube to a feed pipe configured as a thermal stress compensator for a reactor input stream and for lateral introduction of a multipoint thermocouple into the reactor tube,
the use of the connecting piece/measurement apparatus for measuring axial temperature profiles in a reformer tube for steam reforming of hydrocarbons and
a process for installing the measurement apparatus.

The invention especially relates to a measurement apparatus for measuring axial temperature profiles of synthesis gas in one or more reformer tubes in a reforming plant for steam reforming of hydrocarbons to afford a synthesis gas product containing hydrogen and carbon oxides.

### Prior Art

Measurement apparatuses for measuring axial temperature profiles in reactor tubes, in particular in reactor tubes containing a solid, particulate catalyst as a dumped bed, are known per se and described in the literature. Such measurement apparatuses are of great importance for assessment and control of reactor behaviour and reactor control, in particular when the reactor is to be used to perform strongly endothermic or exothermic heterogeneously catalyzed reactions at high reaction temperatures.

Knowledge of the precise axial temperature profile in a reactor tube, for example in a reformer tube of a plant for steam reforming of hydrocarbons to afford synthesis gas, leads to improved understanding of the processes proceeding therein and to optimized and safer control of the reformer plant. Access to this information is highly valuable to prevent excessively high temperatures in particular under non-steady-state conditions, thus preventing thermal destruction of the reformer tube and limiting the risk of undesired carbon formation in the reformer tube. Measured axial temperature profiles in reformer tubes make it possible to determine with great precision the actual degree of achievement of reaction equilibrium. Furthermore, the measured temperatures under practical conditions provide a good basis for future reactor configurations.

However, the introduction of thermocouples into the inside of reformer tubes is a challenge due to the high pressure and temperature conditions. The thermocouple sensor must also be thin enough to prevent disruption to the porosity of the catalytic bed, and pressure sealing must be ensured.

Recent times have seen the commercial introduction of several multipoint thermocouple systems which are said to allow the measurement of internal temperature profiles inside reactor tubes, wherein said systems are configured such that they are able to withstand different and in some cases extreme operating conditions of temperature and pressure. Such a multipoint thermocouple is typically installed such that the compression fitting of the sensor is effected at the upper end of the tube, for example in the upper flange, which is typically only used for catalyst charging. In such an arrangement the input gas mixture is introduced into the reactor tube via a lateral pipe stub into the reactor. Accordingly, in the case of a reformer tube the superheated carbon dioxide-steam mixture is introduced into the reformer tube via a lateral pipe stub while the multipoint thermocouple is introduced via the entry-side sealing flange axially and in alignment with the longitudinal axis of the reformer tube.

A corresponding arrangement of the measurement apparatus and of the reactor tube is shown by way of example in FIG. 1 and also disclosed in US patent application US 201610263542 A1. The multipoint thermocouple described therein is constructed as a monobloc system and consists of about ten individual thermocouples/thermocouple sensors which are arranged in an Inconel shell and embedded in an electrical insulator. The thermocouple sensors are arranged at various heights. The monobloc system is installed along the axis of the reactor tube together with the catalyst loading, and a system of dampers is used to attenuate the fall of the catalyst particles during loading via the upper flange of the reactor tube, thus preventing them from fracturing. Centering of the multipoint thermocouple assembly in the reactor tube is effected via spacers/centering bodies which are successively removed upwards during charging of the reactor tube with the catalyst. The multipoint thermocouple is passed through the entry-side sealing flange axially and in alignment with the longitudinal axis of the reformer tube and electrically connected to the accompanying signal acquisition apparatus via a transmitter. The measured temperatures may then be displayed and/or sent to downstream data processing apparatuses, for example a process control system.

In the case of reformer tubes operated for steam reforming of hydrocarbons the described arrangement of the multipoint thermocouple has certain disadvantages. The high reactor temperatures occurring during steam reforming result in a considerable lengthening of the reformer tubes relative to ambient conditions in the course of operation. In order to reduce the resulting thermal stresses the inlet side and often also the outlet side of the reformer tubes are connected to the inlet/outlet gas distributor system via thermal stress compensators in the form of pipe elbows or pipe coils which are described in the art as “pigtails”. They are connected between the reformer tube and the feed pipe for the superheated hydrocarbon-steam mixture and are connected thereto via weld or flange connections. The lateral arrangement of the feed pipe means there are nevertheless thermal stresses acting on the already highly thermally stressed reformer tube which act perpendicularly to the longitudinal axis of the reformer tube and can therefore result in deformation thereof. Furthermore, the deflection of the gas flow direction of the input gas by an angle of up to 90° from the input pipe into the reformer tube is unfavorable from a flow engineering standpoint since this can result in the formation of zones of relatively high temperature in which increased cracking of the introduced hydrocarbons and thus local coke deposition occurs. For example the region of the reformer tube above the connection point of the feed pipe forms a low-flow zone (dead zone) which is at particular risk of local overheating and thus undesired local coke formation and coke deposition. Supplying the hydrocarbon-steam mixture via a feed pipe arranged in alignment with the reformer tube longitudinal axis in the steam reforming of hydrocarbons would therefore be advantageous and would at least reduce the recited disadvantages, though the multipoint thermocouple shown in in FIG. 1 or described in US 2016/0263542 A1 can then no longer be used in the described manner. There is therefore a need for an apparatus which makes it possible to easily introduce a multipoint thermocouple into the reformer tube also in the case of an axially aligned arrangement of the reformer tube and the feed pipe.

### SUMMARY

It is accordingly an object of the present invention to make it possible to use a multipoint thermocouple in the interior of a reformer tube for catalytic steam reforming of hydrocarbons in a configuration in which the introduction of the input gas into the reformer tube is effected vertically through the upper or lower end of the reformer tube using a feed pipe, wherein the feed pipe configured as a thermal stress compensator or the feed pipe provided with a thermal stress compensator on the one hand and the reformer tube on the other hand are arranged with their longitudinal axes in alignment and are gastightly connectable, for example connected by a flange on the entry-side end of the reformer tube.

A thermal stress compensator is to be understood as meaning a flexible element for compensating movements in pipes, in particular as the result of thermal length changes, for example of reactor tubes. This compensation is effected mechanically, for example via an elastic bellows or via pipe elbows, pipe windings or pipe coils which are elastically deformable along the compensation direction but can simultaneously continue fulfilling their main function as conduits that are fluid-tight with respect to the environment. For example the high reactor temperatures occurring during steam reforming result in a considerable lengthening of the reformer tubes relative to ambient conditions in the course of operation. In order to reduce the resulting thermal stresses the inlet side (feed pipe) and often also the outlet side of the reformer tubes are connected to the inlet/outlet gas distributor system via thermal stress compensators in the form of pipe elbows or pipe coils which are described in the art as “pigtails”. They are connected between the reformer tube and the inlet pipe for the superheated hydrocarbon-steam mixture and/or between the reformer tube and the outlet pipe for the produced raw synthesis gas and connected to these via weld or flange connections.

A transition piece or reducing piece is to be understood as meaning a fitting or a conical pipe piece which may be arranged inside a pipe and forms a transition between two different nominal pipe widths.

References to entry ends and exit ends of tubes or reactors relate to the flow direction of fluids, for example gases, through the tubes or reactors in the course of their intended use.

Multipoint thermocouples measure the temperature at various points along their length as multipoint temperature profile sensors. Their configuration comprises an unearthed (insulated) connection to a plurality of measurement points arranged along the length of the sensor. Commercially available multipoint thermocouples permit the measurement of temperatures up to 1000° C. over lengths of up to several tens of meters. These temperature sensors are often employed in the chemical and petrochemical industry since their use makes it possible to easily obtain temperature profiles for chemical reactors.

For the purposes of the present invention, a fluid connection between two regions of the apparatus of the invention is any type of connection which makes it possible for a fluid, for example a gas stream, to be able to flow from the one region to the other of the two regions, regardless of any regions or components located in between. In particular, a direct fluid connection is to be understood as meaning any type of connection which makes it possible for a fluid, for example a gas stream, to flow directly from one to the other of the two regions, with no further regions or components being interposed, with the exception of purely transportational operations and the means required for this purpose, for example pipes, valves, pumps, compressors, reservoirs. One example would be a pipe leading directly from one to the other of the two regions.

For the purposes of the present invention, a means is something which makes it possible to achieve, or is helpful in achieving, an objective. In particular a securing means is to be understood as meaning a physical article which a person skilled in the art would contemplate for bringing about a preferably gastight connection between two apparatus parts. Securing means which permit feedthrough and gastight securing of a multipoint thermocouple in a feed pipe are in particular configured in the form of a compression fitting, crush fitting or a cutting ring fitting and are commercially available. Some of the recited securing means are detachable and reusable connections and others suitable for repeated use.

A data processing apparatus is to be understood as meaning a computer or any other measurement or control apparatus which is suitable for generating a manipulated variable for particular process parameters of the reactor plant from the measured individual temperature/the measured temperature profile according to a defined algorithm. This may be for example the quantity flow of the reactor feed or the burner output in a reformer furnace.

The invention is based on the finding that for reducing mechanical stresses occurring as a result of lengthening of reactor tubes through thermal expansion it is advantageous when the tube element provided with a thermal stress compensator is arranged in alignment with the reactor tube itself. This lengthening is very pronounced especially in reformer tubes for steam reforming of hydrocarbons when said tubes are heated from ambient temperature to the reaction temperature of nearly 1000° C. in the course of being brought online. The lateral arrangement of the feed pipe known from the prior art results in thermal stresses acting on the already highly thermally stressed reformer tube which act perpendicularly to the longitudinal axis of the reformer tube and can therefore result in deformation thereof. Furthermore, the deflection of the gas flow direction of the input gas by 90° from the input pipe into the reformer tube is unfavorable since this can result in the formation of zones of relatively high temperature in which increased cracking of the introduced hydrocarbons and thus local coke deposition occurs.

Supplying the hydrocarbon-steam mixture via a feed pipe arranged in alignment with the reformer tube longitudinal axis in the steam reforming of hydrocarbons would therefore be advantageous and would at least reduce the recited disadvantages, though the multipoint thermocouple shown in in FIG. 1 or described in US 2016/0263542 A1 can then no longer be used in the described manner.

These problems are solved with the present invention when a connecting piece is provided between the inlet-side tube end (entry end) of the reactor tube and a feed pipe which is intended for introducing a reactor input stream into the reactor tube and which is configured as a thermal stress compensator; this simultaneously serves as a reducing piece or transition piece if the entry end of the reactor tube and the feed pipe have different nominal widths/internal diameters or different flange sizes or if an insulating body in the shape of a pipe piece has been introduced into the entry end of the reactor tube.

According to the invention the first end of the connecting piece has the same internal diameter as the entry end of the reactor tube or as a tubular insulating piece introduced into the entry end of the reactor tube. This brings about reduced local coking by avoiding dead zones or flow separation edges at the entry end of the reactor tube, especially in the case of reformer tubes.

Insulating pieces of the described type may be introduced into the entry end of the reactor tube, in particular a reformer tube, to effect greater thermal insulation of this tube piece. Since in the case of steam reforming the gas mixture entering the reactor tube via the feed pipe exhibits its maximum temperature here thermal insulation of this region is advantageous to minimize heat transfer to the pipe and the supporting steelwork. The insulating piece used therefor is in the shape of a pipe piece or hollow cylinder and is for example fabricated from a material having a lower thermal conductivity than the reactor tube. It is introduced into the entry end of the reactor tube before installation of the connecting piece and secured there using a method known to those skilled in the art. In addition the connecting piece according to the invention also facilitates installation and deinstallation of the feed pipe configured as a thermal stress compensator (pigtail) when such an insulating piece is used since the installation/deinstallation of the feed pipe is now carried out in the direction of the longitudinal axis of the reactor tube and no longer perpendicularly thereto as in the case of a feed pipe having a thermal stress compensator according to the prior art. The entry end of the reactor tube, the connecting piece and the exit end of the feed pipe, for example the cylindrical exit end of the feed pipe having a circular cross section, are during installation arranged one behind the other with their longitudinal axes in alignment and gastightly connected, for example via weld connections or preferably flange connections, since the latter are nondestructively detachable and thus reusable. According to the invention the connecting piece has attached to it a guide tube gastightly connected thereto which opens into the connecting piece and which is provided with a securing means at its end pointing away from the connecting piece. The securing means may consist for example of an outer screw thread attached to the tube end of the guide tube and a corresponding compression fitting, crush fitting or cutting ring fitting, which permit feedthrough and gastight securing of a multipoint thermocouple. It is important here that the angle between the common longitudinal axis of the reactor tube, connecting piece and the exit end of the feed pipe on the one hand and the guide tube on the other hand is between 15° and 60°, preferably between 20° and 45°, and the angle points in the direction of the feed pipe, i.e. points away from the reactor tube. This makes it possible using the guide tube to introduce a multipoint thermocouple via the entry end of the reactor tube into the interior thereof without the force required therefor becoming excessive and while avoiding excessive deformation of the multipoint thermocouple. The bend radius of multipoint thermocouples is more limited compared to individual thermocouples since for each temperature measurement point a corresponding thermocouple must be provided and often all thermocouples are embedded together with their supply leads in a common shell tube, which, while flexible, has limited flexibility due to the greater thickness of the arrangement compared to individual thermocouples.

A second aspect of the connecting piece according to the invention is characterized in that first section, the second section, the at least one transition piece and the guide tube or combinations of these elements are single-piece or multi-piece but gastightly connectable so that all elements in the connected state are in fluid connection with one another. Thus for example the first section, the second section and the one or the combination of two or more transition pieces, for example with cylindrical, straight pipe sections arranged between the transition pieces, may be configured as a common fitting and produced by metal casting, by 3D printing processes, by welding of two or more turned articles to one another or alternatively by machining from solid material. The guide tube is then advantageously gastightly connected to the common fitting by welding.

A third aspect of the connecting piece according to the invention is characterized in that in the connected state the common longitudinal axis of the connecting piece coincides with the center point of the entry end of the reactor tube and with the center point of the exit end of the feed pipe. In this way the occurrence of thermal stresses, in particular of thermal stresses occurring perpendicularly to the longitudinal axis of the reactor tube, is efficiently reduced. Furthermore, local coke deposits through undesired thermal cracking of the introduced hydrocarbons is reduced since dead zones are avoided.

A fourth aspect of the connecting piece according to the invention is characterized in that the first and/or the second section comprise a flange which is gastightly connectable with flange counterparts at the entry end of the reactor tube and/or at the exit end of the feed pipe. Flange connections provide a gastight connection possibility and are nondestructively detachable and thus reusable.

A fifth aspect of the connection piece according to the invention is characterized in that the end of the guide tube pointing away from the connecting piece comprises an outer screw thread, and a pipe screw connection, crush fitting, compression fitting or cutting ring fitting serves as securing means. Such securing means which permit feedthrough and gastight securing of a multipoint thermocouple in a feed pipe are commercially available. Some of the recited securing means provide detachable and reusable connections and are therefore suitable for repeated use. This is important since, generally, emptying of the reactor tube requires removal of the multipoint thermocouple and subsequent charging of the reactor tube with fresh catalyst requires reinstallation of the multipoint thermocouple.

A sixth aspect of the invention relates to a measurement apparatus for measuring axial temperature profiles in a reactor tube comprising:

(a) a connecting piece,

(b) a multipoint thermocouple,

(c) at least one centering body for centering the multipoint thermocouple in the reactor tube, wherein the centering body comprises:
(c1) an inner ring which permits feedthrough of the multipoint thermocouple,
(c2) a multiplicity of spacers which in respect of the inner ring are arranged radially and at equal distances along the outside of the inner ring, wherein the spacers have the same length and the length is chosen such that the circle center point of the inner ring coincides with the longitudinal axis of the reactor tube when the centering body is introduced into the reactor tube and the plane formed by the spacers is arranged perpendicularly to the longitudinal axis of the reactor tube. Centering bodies of the recited type are known per se and are described for example in US patent application US 2016/0263542 A1. However, the use thereof is of particular importance in connection with the present invention since the low maximum bend radius of multipoint thermocouples makes safe guiding and centering thereof particularly important.

In a seventh aspect of the invention the measurement apparatus for measuring axial temperature profiles is configured in a reactor tube charged with a dumped bed of a solid, particulate catalyst and characterized in that the average distance between two adjacent spacers is greater than the average length of the catalyst particles. This ensures that during charging of the reactor tubes the catalyst particles fall past the centering bodies and are not held back thereby since this would hamper the formation of a compact catalyst dumped bed.

An eighth aspect of the invention relates to a process for installing the measurement apparatus according to the invention in a reactor tube for performing endothermic or exothermic heterogeneously catalyzed chemical reactions comprising the steps of:

(a) providing the reactor tube, the measurement apparatus, the feed pipe for the reactor input stream and a solid, particulate catalyst as bulk solid,

(b) passing the multipoint thermocouple through the feed pipe and through the inner rings of at least two, preferably at least three, centering bodies,

(c) introducing the multipoint thermocouple with the centering bodies into the interior of the reactor tube through the entry end thereof,

(d) charging the solid, particulate catalyst up to a specified fill height,

(e) gastightly connecting the connecting piece to the entry end of the reactor tube,

(f) gastightly connecting the connecting piece to the exit end of the feed pipe,

(g) gastightly securing the multipoint thermocouple in the guide tube with the securing means.

Such a process may be advantageously employed especially when the centering bodies do not disrupt the course of the reaction and can remain in the reactor tube during reactor operation.

When performing the process for installing the measurement apparatus according to the invention in a reactor tube it must be ensured that the multipoint thermocouple ideally does not touch the reformer tube inner wall since this can result in measurement errors in subsequent temperature measurements.

In a ninth aspect of the invention the process for installing the measurement apparatus is characterized in that

(a) the charging of the solid, particulate catalyst is carried out up to the lower edge of the lowest centering body,

(b) the lowest centering body is raised by a specified length along the longitudinal axis of the reactor tube,

(c) the steps (a) and (b) are repeated until the specified fill height has been achieved,

(d) the at least one centering body is removed before the connecting of the connecting piece to the reactor tube.

Such a process represents an alternative to the abovementioned aspect of the invention in which the centering body could disrupt the course of the reaction/reactor operation and must therefore be removed before the reactor tube is brought online. To this end it is necessary according to step (d) to remove the centering body/bodies before connection of the connecting piece to the reactor tube. This is for example possible when the centering body is cut along its side, thus allowing lateral removal from the multipoint thermocouple, though this results in destruction of the centering body. It is thus advantageous when the centering bodies are multi-piece and the two or more components are connected for example via screw connections since this allows the centering bodies to be reused in the next charging operation.

In a tenth aspect of the invention the process for installing the measurement apparatus is characterized in that the gastight connecting of the connecting piece to the entry end of the reactor tube and/or the gastight connecting of the connecting piece to the exit end of the feed pipe is carried out using flange connections and/or weld connections. When correctly performed both connection types provide gastight connections and are capable of withstanding high pressures. In addition, flange connections provide the advantage of reversible detachability and reusability.

An eleventh aspect of the invention relates to the use of the connecting piece and/or the measurement apparatus for measuring axial temperature profiles in a reformer tube for steam reforming of hydrocarbons. The proposed connecting piece and measurement apparatus according to the invention are particularly well-suited for this use since the lengthening of the reformer tubes here during heating of the reformer plant from ambient temperature to the reaction temperature is particularly great. The length of reformer tubes is typically 10 meters or more and the lengthening through thermal expansion here may be several decimeters.

### BRIEF DESCRIPTION OF THE DRAWINGS

Developments, advantages and possible applications of the invention are also apparent from the following description of working and numerical examples and the drawings. All features described and/or depicted form, either in themselves or in any combination, the invention, regardless of the way they are combined in the claims or the back-references therein.

FIG. 1 shows an example of a reactor tube for catalytic steam reforming of hydrocarbons having a measurement apparatus for measuring axial temperature profiles according to the prior art (for example US 2016/0263542 A1),

FIG. 2 shows an example of a connecting piece according to the invention for connecting a reactor tube for the catalytic steam reforming of hydrocarbons to a feed pipe configured as a thermal stress compensator for a reactor input stream and for lateral introduction of a multipoint thermocouple into the reactor tube,

### DETAILED DESCRIPTION OF PREFERRED EMBODIMENTS

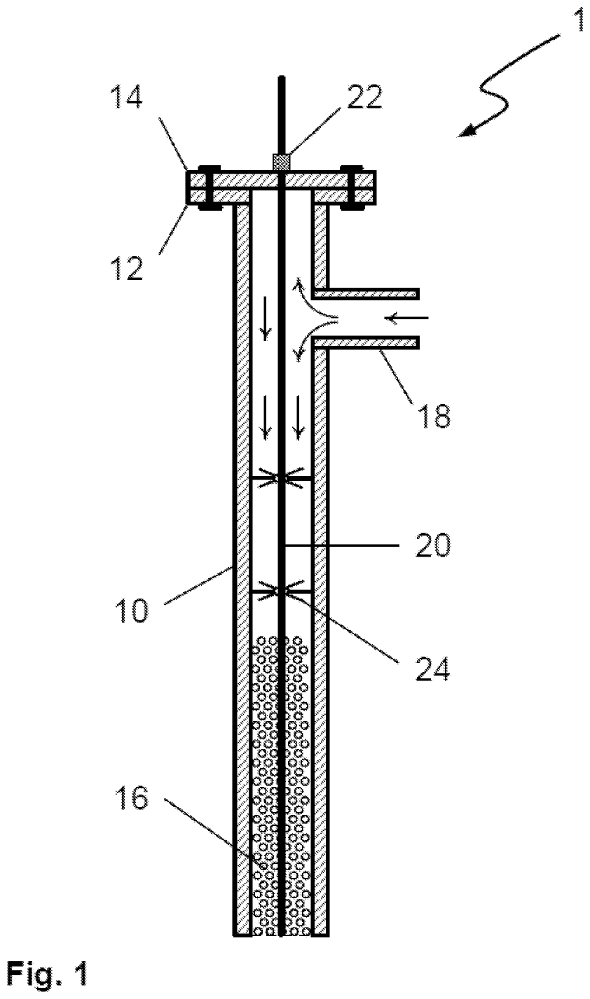

FIG. 1 is an exemplary and schematic diagram of a reactor tube 1 for catalytic steam reforming of hydrocarbons having a measurement apparatus for measuring axial temperature profiles in the reactor tube according to the prior art (for example US 2016/0263542 A1). The arrangement shown comprises a reactor tube 10 having an entry-side flange 12 which is sealed using a flange-connected cap 14. The reactor tube is filled with a dumped bed 16 of a particulate catalyst for steam reforming of hydrocarbons. The hydrocarbons to be reacted, for example methane, butane or naphtha, are mixed with steam to afford a gaseous input mixture and after heating in a heating apparatus (not shown) introduced into the reactor tube 10 using a feed pipe 18. The flow conditions in the gaseous input mixture are indicated by means of flow arrows. It is apparent therefrom that after entering into the entry end of the reactor tube a proportion of the gaseous input mixture initially moves counter to the main flow direction on account of eddy formation since in the region of the internal volume of the reactor tube between the entry side flange and the feed pipe a low-flow dead zone is formed in which the comparatively high residence time of the hot hydrocarbon-steam mixture results in undesired coke formation.

The axial temperature profile inside the catalyst dumped bed is measured using a multipoint thermocouple 20 which may be introduced into the interior of the reactor tube via a bore in the cap. Using a compression fitting 22 the multipoint thermocouple may be secured to the cap 14 gastightly with respect to the environment so that undesired escape of input gas or product gas from the reactor tube under elevated pressure is avoided. To this end the bore in the cap 14 may be provided for example with an inner screw thread (not shown) which may be connected to a corresponding outer screw thread on the compression fitting.

A plurality of centering bodies 24 which are permeable to the gaseous input mixture and—during charging the reactor tube with catalyst—to individual catalyst particles are used to secure the multipoint thermocouple in the tube center of the reactor tube.

In the case of operating the reactor tube 10 for steam reforming of hydrocarbons the described arrangement of the multipoint thermocouple has disadvantages. In the course of operation the high reactor temperatures occurring during steam reforming result in a considerable lengthening of the reformer tube relative to ambient conditions. In order to reduce the associated thermal stresses the feed pipe is for example connected with thermal stress compensators (not shown); alternatively the feed pipe may also be configured as a thermal stress compensator. The lateral arrangement of the inlet pipe means there are nevertheless thermal stresses acting on the already highly thermally stressed reactor tube which act perpendicularly to its longitudinal axis and can therefore result in deformation thereof. Furthermore, the deflection of the gas flow direction of the input gas by angles up to 90° from the inlet pipe into the reactor tube is unfavorable since this can result in the formation of zones of relatively high temperature in which increased cracking of the introduced hydrocarbons and thus local coke deposition occurs. For example the region of the reactor tube above the connection point of the inlet pipe forms a low-flow zone (dead zone) which is at particular risk of local overheating and thus undesired local coke formation.

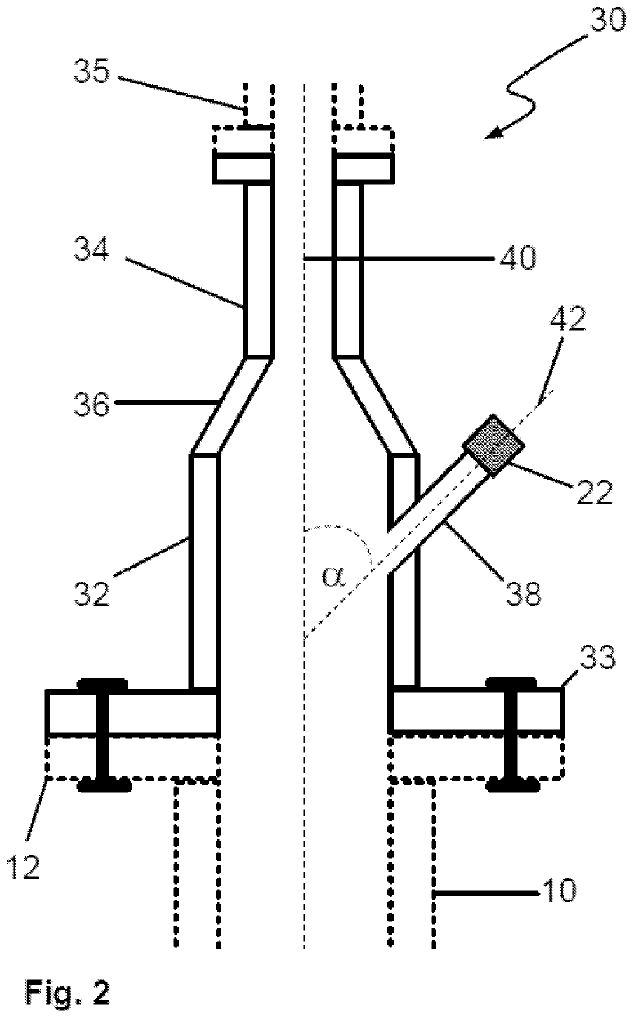

FIG. 2 therefore shows a connecting piece 30 according to the invention which overcomes the recited problems and makes it possible to connect a reactor tube 10 to a feed pipe 34 configured as a thermal stress compensator for a reactor input stream and for lateral introduction of a multipoint thermocouple into the reactor tube. The connecting piece 30 comprises the following constituents:

(a) a first section 32 having a, for example cylindrical, first end which points towards the entry end of the reactor tube 10 and which has the same internal diameter as the entry end of the reactor tube and is gastightly connectable thereto. In the example shown the gastight connection is effected using a flange 33 which is connectable to the reactor tube 10 with a flange counterpart 12. This is indicated by dashed lines in FIG. 2.

(b) a second section 34 having a, for example cylindrical, second end which points towards the exit end of the reactor tube 35 (shown with dashed lines) and which has the same internal diameter as the exit end of the feed pipe 35 and is gastightly connectable thereto. The connection may be produced using a flange provided therefor as indicated in FIG. 2. An alternative connection possibility is that of producing a weld connection.

(c) a transition piece 36 whose first end has the internal diameter of the entry end of the reactor tube 10/the first section 32 and whose second, opposite end has the internal diameter of the exit end of the feed pipe 35/the second section 34.

(d) The constituents (a), (b) and (c) preferably have a circular cross section and a longitudinal axis through the respective circle center point, wherein the constituents are arranged one behind the other with their longitudinal axes in alignment and thus coincide on a common longitudinal axis 40.

(e) The first section 32 has a guide tube 38 attached to it which is gastightly connected to the first section of the connecting piece and opens into the first section 32. The gastight connection between the guide tube and the first section is preferably realized using a weld connection and in an alternative example using a flange connection. The guide tube 38 is provided at its end pointing away from the first section with a securing means 22, for example a pipe screw connection, crush fitting, compression fitting or cutting ring fitting, wherein the securing means permits feedthrough and gastight securing of a multipoint thermocouple (not shown in FIG. 2).

(f) The angle α between the common longitudinal axis 40 and the longitudinal axis of the guide tube 42 is between 15° and 60°, preferably between 20° and 45°, wherein the angle points in the direction of the feed pipe. In other words the angle points away from the reactor tube. In the example shown in FIG. 2 the angle α is 45°. Investigations have shown that the recited angles make it possible using the guide tube to introduce a multipoint thermocouple via the entry end of the reactor tube into the interior thereof without the force required therefor becoming excessive and without excessive deformation being exerted on the multipoint thermocouple. The bend radius of multipoint thermocouples is more limited compared to individual thermocouples since for each temperature measurement point a corresponding thermocouple must be provided and in one example all thermocouples are embedded together with their supply leads in a common shell tube, which, while flexible, has limited flexibility due to the greater thickness of the arrangement compared to individual thermocouples.

In one example of a reactor tube 1 for catalytic steam reforming of hydrocarbons with a measurement apparatus 20 for measuring axial temperature profiles, wherein the installation of the measurement apparatus 20 between the reactor tube 10 and the feed pipe 18 for the input gas containing hydrocarbons and steam is effected using the connecting piece 30 according to the invention. The lateral introduction of the measurement apparatus 20 (multipoint thermocouple) via the guide tube 38 and the centering of the measurement apparatus using the centering body 24 is indicated. It should be noted that this configuration allows introduction of the input gas without dead zones. This reduces the extent of undesired coke deposition in the inlet region of the reactor tube.

In another example of a reactor tube 10 which is configured similarly to the example described above, wherein in a departure therefrom the entry end of the reactor tube is provided with a tubular insulating piece. Accordingly the first section of the connecting piece is configured at its first end pointing towards the entry end of the reactor tube with a narrowing, for example with a frustoconical narrowing, so that the first end of the connecting piece has the same internal diameter as the tubular insulating piece. The configuration of the end of the first section of the connecting piece pointing towards the entry end of the reactor tube with a frustoconical narrowing has the further advantage that it facilitates introduction of the multipoint thermocouple during installation; the frustoconical narrowing acts as a kind of guide element for the thermocouple.

### LIST OF REFERENCE SYMBOLS

[1] Reformer tube
[10] Reactor tube
[12] Flange
[14] Cap
[16] Catalyst dumped bed
[18] Feed pipe
[20] Measurement apparatus (multipoint thermocouple)
[22] Securing means (for example compression fitting)
[30] Connecting piece
[32] First section
[33] Flange
[34] Second section
[35] Feed pipe
[36] Transition piece
[38] Guide tube
[40] Common longitudinal axis of 32, 34, 36
[42] Longitudinal axis of guide tube

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A connecting piece for connecting a reactor tube to a feed pipe configured as a thermal stress compensator for a reactor input stream and for lateral introduction of a multipoint thermocouple into the reactor tube, comprising:
(a) a first cylindrical or frustoconical section having a first end pointing towards a circular entry end of the reactor tube, wherein the first end of the connecting piece has the same internal diameter as the entry end of the reactor tube or as a tubular insulation piece introduced into the entry end of the reaction tube and wherein the first section of the connecting piece is gastightly connectable to the entry end of the reactor tube,
(b) a second cylindrical or frustoconical section having a second end pointing towards a circular exit end of the feed pipe, wherein the second end of the connecting piece has the same internal diameter as the exit end of the feed pipe and is gastightly connectable thereto,
(c) at least one transition piece gastightly connectable to the first and the second section of the connecting piece,
(d) wherein the constituents (a), (b) and (c) have a circular cross section and a longitudinal axis through the respective circle center point, wherein the constituents are arranged one behind the other with their longitudinal axes in alignment and thus coincide on a common longitudinal axis,
(e) a guide tube laterally attached to one of the constituents (a), (b) and (c), gastightly connected to the constituent and opening into the constituent and provided at the end pointing away from the constituent with a securing means which permits feedthrough and gastight securing of a multipoint thermocouple,
(f) wherein the angle between the common longitudinal axis and the longitudinal axis of the guide tube is between 15° and 60 and the angle points in the direction of the feed pipe.

2. The connecting piece according to claim 1, characterized in that first section, the second section, the at least one transition piece and the guide tube or combinations of these elements are single-piece or multi-piece but gastightly connectable so that all elements in the connected state are in fluid connection with one another.

3. The connecting piece according to claim 1, wherein in the connected state the common longitudinal axis of the connecting piece coincides with the center point of the entry end of the reactor tube and with the center point of the exit end of the feed pipe.

4. The connecting piece according to claim 1, wherein the first and/or the second section of the connecting piece comprise a flange which is gastightly connectable with flange counterparts at the entry end of the reactor tube and/or at the exit end of the feed pipe.

5. The connecting piece according to claim 1, wherein the end of the guide tube pointing away from the connecting piece comprises an outer screw thread, and a pipe screw connection, crush fitting, compression fitting or cutting ring fitting serves as securing means.

6. A measurement apparatus for measuring axial temperature profiles in a reactor tube, comprising:
(a) a connecting piece according to claim 1,
(b) a multipoint thermocouple,
(c) at least once centering body for centering the multipoint thermocouple in the reactor tube, wherein the centering body comprises:
(c1) an inner ring which permits feedthrough of the multipoint thermocouple,
(c2) a multiplicity of spacers which in respect of the inner ring are arranged radially and at equal distances along the outside of the inner ring, wherein the spacers have the same length and the length is chosen such that the circle center point of the inner ring coincides with the longitudinal axis of the reactor tube when the centering body is introduced into the reactor tube and the plane formed by the spacers is arranged perpendicularly to the longitudinal axis of the reactor tube.

7. The measurement apparatus according to claim 6 for measuring axial temperature profiles in a reactor tube filled with a dumped bed of a solid, particulate catalyst, wherein the average distance between two adjacent spacers is greater than the average length of the catalyst particles.

8. A process for installing the measurement apparatus according to claim 6 in a reactor tube for performing endothermic or exothermic heterogeneously catalyzed chemical reactions comprising:
(a) providing the reactor tube, the measurement apparatus, the feed pipe for the reactor input stream and a solid, particulate catalyst as bulk solid,
(b) passing the multipoint thermocouple through the feed pipe and through the inner rings of at least two centering bodies,
(c) introducing the multipoint thermocouple with the centering bodies into the interior of the reactor tube through the entry end thereof,
(d) charging the solid, particulate catalyst into the interior of the reactor tube through through the entry end thereof up to a specified fill height,
(e) gastightly connecting the connecting piece to the entry end of the reactor tube,
(f) gastightly connecting the connecting piece to the exit end of the feed pipe,
(g) gastightly securing the multipoint thermocouple in the guide tube with the securing means.

9. The process for installing the measurement apparatus according to claim 8, wherein
(a) the charging of the solid, particulate catalyst is carried out up to the lower edge of the lowest centering body,
(b) the lowest centering body is raised by a specified length along the longitudinal axis of the reactor tube,
(c) the steps (a) and (b) are repeated until the specified fill height has been achieved,
(d) the at least one centering body is removed before the connecting of the connecting piece to the reactor tube.

10. The process for installing the measurement apparatus according to claim 8, wherein the gastight connecting of the connecting piece with the entry end of the reactor tube and/or the gastight connecting of the connecting piece with the exit end of the feed pipe is carried out using flange connections and/or weld connections.
